(19) United States
(12) Patent Application Publication
(10) Pub. No.: US 2023/0290208 A1
(43) Pub. Date: Sep. 14, 2023

(54) SECURE ELECTRONIC VOTING METHOD AND APPARATUS

(71) Applicant: James McNulty, Paulsboro, NJ (US)

(72) Inventor: James McNulty, Paulsboro, NJ (US)

(21) Appl. No.: 17/586,363

(22) Filed: Jan. 27, 2022

(51) Int. Cl. G07C 13/00; H04L 9/08; H04L 9/32

(52) U.S. Cl. CPC G07C 13/00; H04L 9/0825; H04L 9/0866; H04L 9/0894; H04L 9/3231; H04L 2209/463

(57) ABSTRACT

A user using a client computer registers with a server computer over a computer network by submitting a biometric scan of a body part of the user. The user who commands the client computer to encrypt an electronic ballot becomes the ballot owner. The client computer generates a private key, encrypts the electronic ballot, and transmits the key to a key server computer. The ballot owner grants permission to another registered user authorizing them access to the private key to decrypt the encrypted ballot and to re-encrypt the electronic ballot. The permitted registered user enters selections onto the decrypted electronic ballot, encrypts it and transmits the ballot back to the ballot owner. The ballot owner decrypts the cast ballot and records the selections made by the permitted user.

### CROSS REFERENCE TO RELATED APPLICATIONS

This is a continuation of application Ser. No. 15/948,579, file Apr. 9, 2018, which is a division of application Ser. No. 14/545,514, filed May 14, 2015, which is a division of application Ser. No. 12/586,322, filed Sep. 21, 2009, the entire contents of which are hereby incorporated herein by reference.

### I. REFERENCE TO A COMPUTER PROGRAM LISTING APPENDIX

The computer program listing appendix attached to application Ser. No. 15/948,579 in the form of a compact disc pursuant to 37 CRF 1.52(e), 1.77(b)(5) and 1.96(c), is hereby incorporated by reference. The following files of the compact disc are hereby incorporated by reference:

| Date of Creation | Bytes | Name |
|---|---|---|
| Directory of C:\IMM-source\CSA | | |
| Mar. 06, 2009 01:28 PM | 1,282 | AssemblyInfo.cs.txt |
| May 20, 2009 01:29 PM | 16,073 | BlowfishAlgorithm.cs.txt |
| May 20, 2009 11:25 AM | 16,604 | BlowfishCFC.cs.txt |
| May 20, 2009 11:25 AM | 17,605 | BlowfishCFB.cs.txt |
| May 20, 2009 11:25 AM | 39,342 | BlowfishECB.cs.txt |
| May 20, 2009 11:25 AM | 8,785 | BlowfishSimple.cs.txt |
| Aug. 28, 2009 02:11 PM | 6,722 | Captureform.cs.txt |
| Aug. 28, 2009 01:49 PM | 12,043 | Captureform.designer.cs.txt |
| Sep. 10, 2009 07:41 PM | 9,810 | CCWform.cs.txt |
| Jun. 21, 2009 06:48 PM | 27,395 | CCWform.Designer.cs.txt |
| Sep. 10, 2009 09:28 PM | 43,014 | CCWNew.Designer.cs.txt |
| Jun. 14, 2009 01:26 AM | 1,162 | ChooseFile.cs.txt |
| Jun. 14, 2009 01:26 AM | 4,211 | ChooseFile.Designer.cs.txt |
| May 19, 2009 03:16 PM | 519 | CSAMain.cs.txt |
| May 19, 2009 03:16 PM | 7,473 | CSAMain.Designer.cs.txt |
| May 19, 2009 02:47 PM | 2,333 | EnrollmentForm.cs.txt |
| Sep. 08, 2009 03:13 AM | 14,386 | FHeLocker.cs.txt |
| Sep. 01, 2009 01:05 PM | 18,938 | Filelocker.Designer.cs.txt |
| Sep. 11, 2009 12:36 AM | 978 | FHeOpener.cs.txt |
| Sep. 10, 2009 11:03 PM | 3,413 | FHeOpener.Designer.cs.txt |
| Sep. 17, 2009 10:16 AM | 43,368 | Form1.cs.txt |
| Sep. 08, 2009 03:05 AM | 30,110 | Form1.Designer.cs.txt |
| Jun. 05, 2009 03:16 PM | 969 | Licenseform.cs.txt |
| Jun. 05, 2009 03:16 PM | 3,384 | Licenseform.Designer.cs.txt |
| Jun. 22, 2009 11:49 PM | 10,782 | Modifyform.cs.txt |
| Jun. 22, 2009 11:49 PM | 27,411 | Modifyform.Designer.cs.txt |
| Sep. 11, 2009 12:37 AM | 23,750 | MyFHesform.cs.txt |
| Sep. 10, 2009 10:08 PM | 38,501 | MyFilesform.Designer.cs.txt |
| Jun. 15, 2009 10:46 PM | 417 | MyPolky.cs.txt |
| Jun. 14, 2009 02:42 AM | 512 | PinstanceItem.cs.txt |
| Aug. 31, 2009 03:22 PM | 6,602 | POMform.cs.txt |
| May 25, 2009 04:21 AM | 13,609 | POMforn.Designer.cs.txt |
| Sep. 17, 2009 12:14 AM | 658 | Program.cs.txt |
| Aug. 31, 2009 04:52 PM | 9,485 | Reference.cs.txt |
| Mar. 06, 2009 01:28 PM | 2,847 | Resources.Designer.cs.txt |
| Aug. 31, 2009 12:49 PM | 14,703 | ress.Designer.cs.txt |
| Aug. 31, 2009 04:52 PM | 2,216 | Settings.Designer.cs.txt |
| Mar. 26, 2009 08:44 PM | 353 | UruFileItem.cs.txt |
| Jun. 21, 2009 01:58 AM | 380 | utils.cs.txt |
| 40 File(s) 495,586 bytes | | |
| Directory of C:\IMM.cndot.source\filestore | | |
| Aug. 31, 2009 04:19 PM | 1,623 | fs9935.asmx.cs.txt |
| Directory of C:\IMM-source\server | | |
| Sep. 02, 2009 10:41 PM | 464 | account.aspx.cs.txt |
| Sep. 13, 2009 02:46 PM | 489 | account.aspx.designer.cs.txt |
| Sep. 13, 2009 02:47 PM | 281 | account.aspx.txt |
| Sep. 03, 2009 06:49 AM | 463 | admin.aspx.cs.txt |
| Sep. 03, 2009 06:49 AM | 488 | admin.aspx.designer.cs.txt |
| Sep. 13, 2009 02:52 PM | 497 | admin.aspx.txt |
| Mar. 10, 2009 02:03 AM | 1,411 | AssemblyInfo.cs.txt |
| Sep. 17, 2009 07:05 PM | 68,089 | bw56195.asmx.cs.txt |
| Sep. 17, 2009 08:46 PM | 6,580 | CaptchaClass.cs.txt |
| Sep. 03, 2009 06:46 AM | 3,210 | confirm.aspx.cs.txt |
| May 19, 2009 01:34 AM | 548 | confirm.aspx.designer.cs.txt |
| Jun. 05, 2009 03:31 AM | 423 | confirm.aspx.txt |
| Sep. 07, 2009 08:45 PM | 2,709 | events.aspx.cs.txt |
| Sep. 13, 2009 01:47 PM | 625 | events.aspx.designer.cs.txt |
| Sep. 13, 2009 03:38 PM | 2,312 | events.aspx.txt |
| Sep. 02, 2009 10:42 PM | 461 | home.aspx.cs.txt |
| Sep. 13, 2009 02:46 PM | 486 | home.aspx.designer.cs.txt |
| Sep. 13, 2009 02:47 PM | 277 | home.aspx.txt |
| Sep. 17, 2009 08:34 PM | 1,112 | jpegimage.aspx.cs.txt |
| Sep. 03, 2009 12:02 AM | 548 | jpegimage.aspx.designer.txt |
| Sep. 03, 2009 12:02 AM | 454 | jpegimage.aspx.txt |
| Sep. 03, 2009 05:52 AM | 2,047 | login.aspx.cs.txt |
| Sep. 03, 2009 12:17 AM | 549 | login.aspx.designer.cs.txt |
| Sep. 17, 2009 08:35 PM | 5,192 | login.aspx.txt |
| Sep. 13, 2009 03:42 PM | 1,502 | masterpage1.Master.cs.txt |
| Sep. 13, 2009 02:55 PM | 1,165 | masterpage1.designer.cs.txt |
| Sep. 03, 2009 06:34 PM | 3,659 | pendingusers.aspx.cs.txt |
| Sep. 13, 2009 03:44 PM | 619 | pendingusers.designer.cs.txt |
| Sep. 13, 2009 03:44 PM | 2,629 | pendingusers.aspx.txt |
| Sep. 12, 2009 01:47 AM | 6,277 | signup.aspx.cs.txt |
| Sep. 03, 2009 02:37 AM | 741 | signup.aspx.designer.cs.txt |
| Sep. 17, 2009 08:35 PM | 6,175 | signup.aspx.txt |
| Mar. 10, 2009 10:43 PM | 463 | Site1.Master.cs.txt |
| May 19, 2009 01:26 AM | 688 | Site1.Master.designer.cs.txt |
| Jun. 21, 2009 05:49 AM | 1,883 | Site2.Master.ds.txt |
| Jun. 21, 2009 05:48 AM | 888 | Site2.Master.designer.cs.txt |
| Sep. 02, 2009 10:42 PM | 463 | store.aspx.ds.txt |
| Sep. 13, 2009 02:46 PM | 487 | store.aspx.designer.cs.txt |
| Sep. 13, 2009 02:46 PM | 277 | store.aspx.txt |
| Apr. 21, 2009 03:27 PM | 1,146 | userinfo.cs.txt |
| Sep. 03, 2009 08:00 AM | 2,536 | usermgmt.aspx.cs.txt |
| Sep. 03, 2009 07:35 AM | 680 | usermgmt.aspx.designer.txt |
| Sep. 03, 2009 06:15 PM | 2,183 | usermgmt.aspx.txt |

### II. BACKGROUND OF INVENTION

### A. Field of the Invention

The invention relates to a secure electronic voting method and apparatus using a biometric identifier and a computer network such as the Internet or an Intranet. The invention has particular application for secure election events and the elimination of voter fraud and ballot tampering.

### B. Description of the Related Art

The implementation of modern election security requires that the identity of the registered eligible voter be authenticated without the requirement or dependency on State or Federally issued identification certifications. The increased demand for absentee or mail-in ballots and the systems and protocols that have been established to enable this option and entitlement do not ensure accurate and verifiable registered voter identification authentication and do not ensure that the ballots requested or issued will be received and returned in the acceptable and permissible time period specified.

Delays in the receiving and processing of mail-in and absentee ballots can result in the surpression and elimination of eligible voters participation in the electorial process. The current voter verification process of signature comparisions and/or accompanying copies of State and Federally issued identification is ripe with potential acts of fraud and tampering. The reliance and dependency on the availability of an acceptable form of State or Federally issued identification certification disenfrancshises a substantial portion of the voter electorate that does not have access or is not in possession of current and acceptable forms of the required identification. The potential for ballots to be intercepted and/or altered and destroyed creates an enviornment in which accurate votes can be modified or discounted and/or inaccurate and illegal votes can be substituted and submitted for consideration.

Prior art alternative voting systems and procedures do not teach the secure electronic voting method and apparatus of the Invention.

### III. BRIEF DESCRIPTION OF THE INVENTION

The invention is an apparatus and method for a secure electronic voting system and procedure that ensures accurate identification of eligible registered voters and eliminates the opportunities and conditions for fraud in which ballots are lost, disregarded, stolen, altered or modified.

A client computer under the control of a user communicates with a server computer under the control of a service provider over a computer network such as the internet or intranet. The client computer is operably connected to a biometric scanner such as a fingerprint scanner. The identity of the human user is verified to the client computer and to the server computer by the user providing a user name and a biometric identifier, the biometric identifier comprising the results of a biometric scan using the biometric scanner.

A file is resident in the client computer memory. Upon command by the user, the client computer generates a private key and encrypts the file using the private key. The client computer trasmits the private key to the server computer, which stores the private key in a private key computer memory. The private key computer memory and the encrypted file memory are in different physical locations. The encrypted file computer memory may be associated with the client computer or may be at a different physical location than the client computer.

As used in this document, a ‘client computer’ means any computer under the control of a user that is operably connected to a biometric scanner and capable of communicating with a server over a computer network such as the internet or an intranet. The term ‘server computer’ means any computer under the control of a service provider and capable of communicating with the client computer over the computer network.

As used in this document, the term ‘different physical location’ means different street address or any other physical separation so that a physical invasion of the location in which the encrypted file computer memory is housed will not alos be a physical invasion of the location where the private key computer memory is housed.

While the private key and the encrypted file will reside temporarily in memory on the same client computer during encryption and decryption of the file, the temporary memory is erased and overwritten after the encryption or decryption operation is completed. The encrypted file and the private key are not store in onon-volatile memory on a single computer or at a single physical location.

To use the apparatus and method of the invention, a user utilizing a client computer logs onto a computer network and navigates to a website controlled by a service provider or to an equivalent intranet location. The user registers with the service provider to become a registered user. To register, the user transmits from the client computer to the server computer a user name and biometric identifiers to identify the user. As used in this application, the term ‘biometric template’ refers to the biometric identifer stored in the memory of the server computer during the registration operation in which the user becomes a registered user.

As used in this application, the term ‘biometric identifier’ means a fingerprint scan provided by a fingerprint reader, an iris scan provided by an iris scanner, a voice print scan provided by a voice print scanner, the results of a facial recognition scan, or any other electronic data file generated by an electronic scan of a body part of a user. The server computer associates the username and biometric identifiers with the user and approves the user as a registered user. As used in this application, the term ‘registration server’ refers to the server computer that associated the username and the biometric identifiers with the user and approved the user as a registered user.

Upon registration, the registered user downloads a client-side application (“CSA”). The CSA is a computer program for installation on the client computer. The CSA is configured to communicate with the server computer and to encrypt and decrypt the files when requested by a logged-on, registered, authorized user. The user installs the CSA on each client computer from which the user will encrypt and decrypt files.

To encrypt or decrypt records, the user launches the CSA on a client computer and logs on to the registration server computer over a computer network. During logon, the user will provide the user name and biometric identifier such as a contemporaneous fingerprint scan. The registration server will compare the username and biometric identifier against the registration information and biometric template stored in the registration server computer memory.

If the user name matches and the registration server computer concludes that the biometric identifier submitted is of the same person as the biometric identifier template stored in the registration server computer memory, then the registration server computer will recognize the user as a registered user and allow the registered user to complete the logon operation.

To encrypt a file, the logged-on registered user will designate a file on the CSA and command the CSA to encrypt the file. The CSA will assign a private key to the file and encrypt the file using the private key. The CSA will apply conventional private key encryption algorithms to select the private key and encrypt the file.

The CSA transmits the private key to a server computer along with the information to associate the private key with the encrytped file for subsequent decryption. The information to associate the private key with the file may include the user name and the date and time of the encryption. As used in this application, the term ‘private key server’ refers to the computer which receives the transmitted private encrytion key for the encrypted file and stores the private encryption key in the server computer memory.

The logged-on, registered user who commands the CSA to encrypt the file is the ‘owner’ of the encrypted file. The owner of the encrypted file can designate that a registered user has permission to retrieve the private key from the private key server computer and decrypt the encrypted file. The owner of the encrypted file can designate that said registered user also has permission to retrieve the private key from the private key server computer and re-encrypt the decrypted electronic file.

The designation by the file owner to another registered user to retrieve the private key from the private key server and decrypt the encrypted file and re-encrypt the decrypted electronic file is referred to herein as a ‘permission’.

As used in this application, a registered user that has received the encryted file and has been granted permission by the file owner to decrypt and re-encrypt the encrypted file is referred to herein as an ‘Electronically Registered Voter’ (“ER voter”).

As used in this application, the encrypted file that has been transmitted by the file owner to the permitted ER voter is referred to herein as the ‘electronic ballot’ (“ballot”).

The client computer of the ballot owner transmits the permission to the private key server computer, which associates the permission with the encrypted file and the associated private encryption key and stores the permission in the private key server computer memory.

The ‘owner’ of the ballot has permanent ‘permission’ and can always request the private encryption key and decrypt/encrypt the ballot.

When a permission is granted to an ER voter by the ballot owner, the permission is a effective for two separate instances or ‘parts’ the ‘first part’ being for the retrieval of the private encryption key and a single instance of the decryption of the ballot and the ‘second part’ being the subsequent retrieval of the private encryption key for a single instance of the re-encryption of the ballot.

The ER voter will have to submit a biometric identifier to the registration server and have their identity biometrically authenticated as a conditional requirement for being able to exercise each ‘part’ or separate instance of the permission, the first time for the retrieval of the private key and the decryption of the ballot and a second and separate time for being able to exercise the permission to retreive the private key and re-encrypt the ballot.

Permissions also may be for a specific duration and may expire or become inactive at the end of a specific period. The ballot owner may issue, revoke or modify a permission at any time. The permission of the ballot owner does not expire and continues indefinitely.

The ballot owner can grant a permission to individuals, groups or companies, such as a group consisting of registered, designated and authorized subset of election official employees or a company consisting of registered members of an audited or forensic task force unit.

To decrypt the ballot, the user must be registered, logged-on to the registration server and be the owner or the ER voter or otherwise have permission to open and access the ballot. The user will select the encrypted ballot and will command the encrypted file to open.

The CSA will communicate with the registration server and receive verification from the server that the user attempting to decrypt the ballot has had their identity biometrically authenticated and is the ballot owner or the ER voter that has been given permission by the ballot owner to unlock or decrypt the ballot and that the permission is still in effect.

The CSA will retreive the private key from the private key server computer memory and will decrypt the ballot using the private key. Immediately upon decryption of the ballot the CSA will erase and overwrite the temporary volatile memory of the client computer. The ER voter may then open the decrypted ballot which will be displayed on the computer monitor of their client computer and access the information contained in the ballot.

The ER voter may then ‘fill out’ the ballot by making their designated choices and selections. This may be accomplished by selecting the appropriate radial buttons and/or by manuvering the mouse and hovering over and clicking on the desired option. The ballot may include text field boxes in which the ER voter may ‘write-in’ the name of a candidate or option that does not appear on the ballot.

Once completed the ER voter may review their ballot to ensure that it has been correctly compiled. When the ballot has been correctly completed and approved by the ER voter they will select the ‘cast your vote’ option to submit the ballot.

The identity of the ER voter will be verified by matching a real-time biometric identifier with the biometric identifier template associated with the user that is stored in the memory of the registration computer.

Once the identity of the ER voter has been biometrically authenticated the CSA will communicate with the registration server and recieve verification that the ER voter has been given permission by the ballot owner to re-encrypt the ballot and that the permission is still in effect.

The CSA will retrieve the private encryption key associated with that ballot from the private key server to the temporary memory of the ER voter’s client computer and will encrypt the ballot using the private key. Immediately upon the encryption of the ballot the CSA will erase and overwrite the temporary memory of the client computer.

The client computer of the ER voter will transmit the encrypted ballot to the computer of the ballot owner. The identity of the ballot owner will be verified by matching a real-time biometric identifier with the biometric identifier template associated with the user that is stored in the memory of the registration computer.

Once the identity of the user has been biometrically authenticated the CSA will communicate with the registration server and will receive verification that the user is the ballot owner of the encrypted ballot.

The CSA will retrieve the private encryption key associated with the encrypted ballot from the private key server to the temporary memory of the ballot owner’s client computer and will decrypt the ballot using the private key. Immediately upon the decryption of the encrypted ballot the CSA will erase and overwrite the temporary memory of the client computer.

The ballot owner will tally and record the choices and designated selections submitted by the ER voter. The ballot owner will not be able to alter, modify or manipulate the decrypted ballot but will have the option of printing or creating a ‘hard copy’ of the submitted electronic ballot.

The ballot owner can then select the option to encrypt the ballot and transmit the tallied encrypted ballot to the memory of an encrypted ballot computer for storage. The CSA will have to communicate with the registration server and the identity of the user will have to be biometrically authenticated as the ballot owner in order to enable the option of the encryption and storage of the tallied ballot.

A log will be created and mantained for each action and operation associated with the electronic ballot. This will include but will not be limited to the creation of the electronic ballot, the encyption of the ballot by the ballot owner, the granting of the permissions associated with the encrypted ballot to the ER voter, the transmission, location and receipt of the encrypted ballot to the desiganted ER voter’s client computer, the ER voter’s decryption of the encrypted ballot, the processing of the electronic ballot by the ER voter, the re-encryption and ‘cast your vote’ submission the ballot by the ER voter, the transmission to and receipt of the completed encrypted ballot by the client computer of the ballot owner, the decryption and tally of the submitted ballot by the ballot owner, the generation of a printed or ‘hard copy’ of the ballot and the encryption and transmission of the tallied ballot to an encrypted ballot computer memory for storage.

As an additional layer of security a ‘check sum’ or hash tag algorithm may be employed and an unique value attached to the completed ballot upon the casting or submission of the completed ballot by the ER voter in conjunction with the corresponding encryption operation. The unique hash tag value will be recorded and associated with completed ballot and will be checked verified during each and every subsequent activity and operation associated with the ‘casted’ ballot. This will provide additional verifiable security that will ensure that no alteration, modification or prohibited activity has occurred once the ballot has been completed and submitted by the ER voter.

### IV. BRIEF DESCRIPTION OF THE DRAWINGS

FIG. 1 is a block diagram of the system architecture.

FIG. 2 is a flow chart of the registration process.

FIG. 3 is a flow chart of the Client Side Application logon process.

FIG. 4 is a flow chart of the IDAV process.

FIG. 5 is a flow chart of encrypting the electronic ballot.

FIG. 6 is a flow chart of decrypting and casting the electronic ballot.

FIG. 7 is a flow chart of tallying and recording the cast ballots.

FIGS. 8-10 are images of screens presented during logon of the CSA.

### V. DESCRIPTION OF AN EMBODIMENT

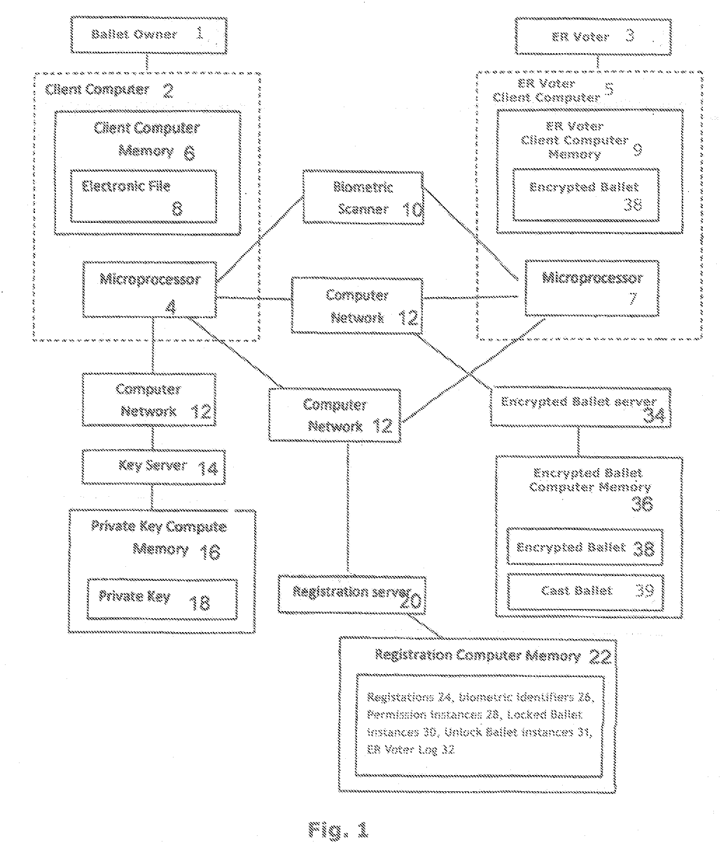

One aspect of the invention is an apparatus and method for a secure electronic voting system and procedure. FIG. 1 is a block diagram of the initial system architecture. A file owner 1, hereninafter defined and referred to as the ‘ballot owner’, operates a client computer 2, that includes a microprocessor 4 and a client computer memory 6. The client computer memory 6 is accessible to the microprocessor 4. The client computer memory is capable of storing an electronic file 8, (referred to in this document as the electronic ‘ballot’) The electronic ‘ballot’ 8 contains the voting information and choices that will be securely transmitted, retrieved, tallied and stored by the system. A biometric scanner 10 is connected to the microprocessor 4. The biometric scanner 10 is capable of scanning a body part of the human user to generate a biometric identifier 26. The biometric scanner 10 may be a fingerprint scanner, an iris scanner, a facial recognition scanner or any other scanning device capable of generating an electronic file that is unique to a human user and requires the ‘real-time’ presence of the human user to perform the scan. The biometric identifier 26 is an electronic file that contains the results of the biometric scan.

An electronically registered voter 3, hereninafter defined and referred to as “ER voter”, operates a client computer 5, that includes a microprocessor 7 and a client computer memory 9. The client computer memory 9 is accessible to the microprocessor 7. The client computer memory is capable of storing an electronic ballot 8. The electronic ‘ballot’ 8 will contain the voting information, selections and choices made by the ER voter 3 and will be securely recieved, stored and transmitted by the system. A biometric scanner 10 is connected to the microprocessor 7. The biometric scanner 10 is capable of scanning a body part of the human user to generate a biometric identifier 26. The biometric scanner 10 may be a fingerprint scanner, an iris scanner, a facial recognition scanner or any other scanning device capable of generating an electronic file that is unique to a human user and requires the ‘real-time’ presence of the human user to perform the scan. The biometric identifier 26 is an electronic file that contains the results of the biometric scan.

The client computer 2 in the control of the ballot owner 1 and the client computer 5 in the control of the ER voter 3 are capable of communicating with each other and with other computers over a computer network 12. The computer network 12 may be the Internet or an Intranet or may be any other network of computer capable of communicating one with another.

A key server 14 is connected to the microprocessor 4 of the client computer 2 of the ballot owner 1 and the microprocessor 7 of the client computer 5 of the ER voter 3 over the computer network 12. The key server 14 is connected to a private key computer memory 16. Private key computer memory 16 is accessible to the key server 14. Private key computer memory 16 is capable of storing a private key 18. Private key 18 is a private encryption key generated and used to encrypt the electronic ballot 8 as the term is commonly applied when the method of private key encryption is utilized.

A registration server 20 is attached to microprocessor 4 of the client computer 2 of the ballot owner 1 and the microprocessor 7 of the client computer 5 of the ER voter 3 over the computer network 12. The registration server 20 is connected to a registration server computer memory 22. The registration server computer memory 22 is capable of storing the registration status 24 of the human users, biometric identifiers 26 of registered users, permissions 28 granted by a user, and locked file instances 30 and unlock file instances 31 for each registered user, as those terms are hereinafter used and defined.

An encrypted file server 34 communicates with the client computer 2 of the ballot owner 1 and the registration server 20 over the computer network 12. An encrypted file computer memory 36 is connected to and in communication with the encrypted file server 34. The encrypted file computer memory 36 is capable of storing the encrypted ‘casted’ ballot 38, a term hereinafter used and defined, of an ER voter 3.

The encrypted file server 34 and the key server 14 are separate servers and are not the same. Encrypted file computer memory 36 is in a different physical location for the private key computer memory 16. Maintaining encrypted file computer memory 36 and private key computer memory 16 at different physical locations prevents the loss of both an encrypted ballot 38 and the private key 18 to unlock the encrypted ballot in a single action of physical theivery or a single incident of hacking.

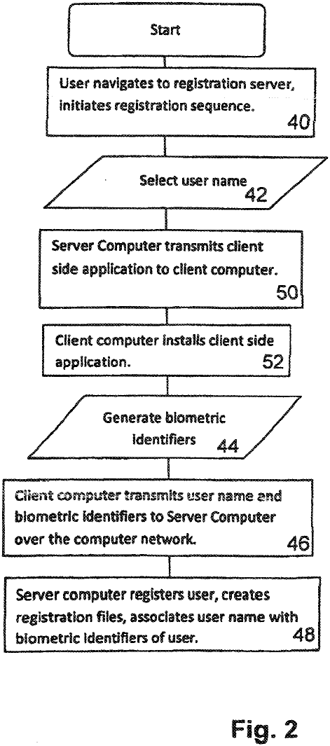

FIG. 2 is a flow chart illustrating the registration process to transform a user into a registered user authorized as the electronic ballot owner 1 or as an E.R. voter 3 that can participate in the secure voting system and procedure appartus and method of the Invention. A human user utilizing client computer 2 or client computer 5 navigates through the computer network 12 to the registration server 20, illustrated as item 40. The registration server 20 will request, and the user will select, a user name, which the microprocessor 4 of client computer 2 or the microprocessor 7 of client computer 5 transmits to the registration server 20 over the computer network 12, shown by item 42 of FIG. 2.

During the registration process, the registration server 20 will transmit a Client Side Application (“CSA”) to the client computer over the computer network 12, as shown by item 50.

The client computer will install the CSA as shown by item 52. The CSA is a computer program resident in client computer memory 6 or client computer memory 9 that automates many of the encryption, decryption and communication functions of the apparatus and method of the Invention. The CSA also provides gatekeeper functions in allowing or refusing access by the user to the registration server 20, key server 14 and encryption file server 34.

The registration server 20 will request a biometric identifier 26. The user uses biometric scanner 10 to scan a body part of the user, for example the user’s fingerprint, as illustrated by item 44. The microprocessor will tranmit the biometric identifier 26 to the registration server 20, as shown by item 46. The registration server 20 will create a registration account for user, transforming the user into a registered user as shown by item 48. The registration server 20 will associate the user name and the submitted biometric identifiers 26.

The registered user may be an individual. Alternatively, a group or company may be registered comprising more than one individual under the control of a chairman. Where a group or company comprises more than one individual, each individual nonetheless will provide biometric identifiers 26, which may be one or more scans of a body part of the individual by biometric scanner 10. The biometric identifier 26 and username of each person in the group or company will serve to allow each group member or company employee (i.e. such as a certified election official) to identify him or herself to the registration server 20 to allow access to the encrypted ballots 38 and associated private keys 18. The chairman of the group or company can determine access limitations of individual members of the group or employees of the company.

The process of encrypting and decrypting a file using a private key 18 are also referred to in this document as ‘locking’ and ‘unlocking’ the ballot. ‘Locking’ means ‘encrypting’. ‘Unlocking’ means ‘decrypting’. An encrypted ballot 38 is also referred to as a ‘locked ballot’ 38 while an unencrypted electronic ballot 8 is referred to as an ‘unlocked ballot’ 8.

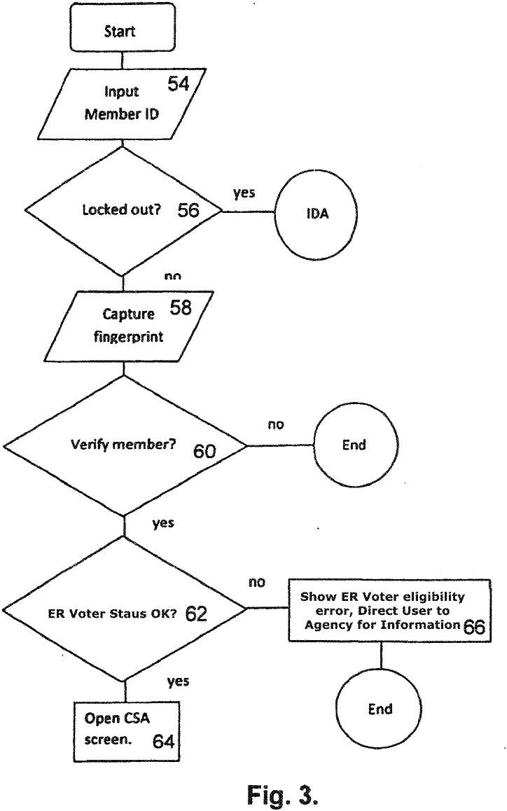

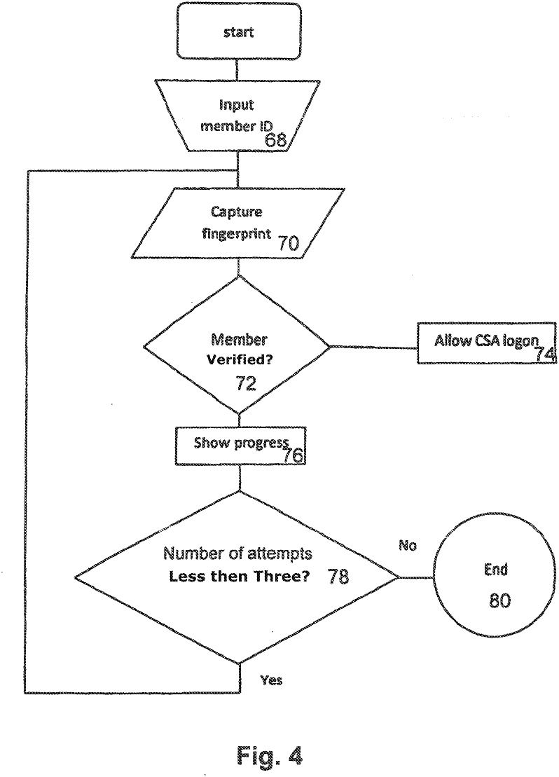

To access the encryption and decryption functions of the apparatus and method, the user logs on to the CSA resident client computer 2 or client computer 5. FIG. 3 is a flow chart illustrating the CSA logon process. To log on to the CSA, the registered user will open the CSA (Client Side Application) on client computer 2 or client computer 5. The registered user will input the user’s member ID, also referred to herein as the ‘user name’, indicated as item 54 on FIG. 3. The CSA will consult with the registration server 20 over computer network 12 to determine whether the user is ‘locked out’, item 56 of FIG. 3. If the CSA recieves notice from the registration server 20 that the registered user is ‘locked out’ and prohibited from ‘logging on’, the CSA will require the user to go through the identification process shown by FIG. 4. The registration server might lock out a registered user for electronic voter disqualification or ineligibility, for activity on the user’s account that may indicate a security breach, or for any other reason.

If the user is not ‘locked out’, the CSA will request that the registered user provide a biometric identifier 26, which may be a fingerprint as illustrated by item 58 of FIG. 3. The registered user will place his or her finger on the biometric scanner 10, which will scan a body part of the user. Client computer 2 or client computer 5 will generate a ‘real-time’ biometric identifier 26, which client computer 2 or client computer 5 will transmit to the registration server 20 over the computer network 12. The registration server will verify the identity of the user, item 60 of FIG. 3, by comparing the biometric identifier 26 received from client computer 2 or client computer 5 to the biometric identifier 26 associated with the user’s user name in registration computer memory 22. If the registration server 20 concludes that the biometric identifier 26 recieved from client computer 2 or client computer 5 is from the same person as the biometric identifier 26 stored in the registration computer memory 22 and associated with the user’s user name, the registration server will conclude that the registered user is who he or she claims to be and their identity will have been ‘biometrically authenticated’.

The registration server 20 will also check the current status and ‘voter eligibility’ of the electronically registered voter (ER voter). If the user is the ER voter who he or she claims to be and if their current status and voter eligibility is active and approved then the CSA will display the CSA Control Operations Window and information field screen to the ER voter, item 64 of FIG. 3 to allow the ER voter to decrypt and encrypt the electronic ballot. If the ER voter status is not active and they are not currently eligible to vote electronically the CSA will so indicate to the ER voter, shown by item 66 of FIG. 3, and not allow access to the CSA Control Operations Window and information field screen to the unapproved ER voter.

If the initial logon to the CSA is not successful in matching the user name to the biometric identifier 26 stored in the registration computer memory 22, or if an inaccurate member name was entered on a third failed attempt, the application will ‘auto-quit’ and close. In the process illustrated by FIG. 4, the user for whom the biometric identifier 26 and user name did not match is given two more attempts to logon. The user will re-input the user’s user name, indicated by item 68 of FIG. 4. The user submits another biometric identifier 26, such as a fingerprint scan, from item 70 of FIG. 4. If the user name and the biometric identifier 26 match those stored in the registration computer memory 22, from item 72 on FIG. 4, then the user is allowed to logon to the CSA, item 74 of FIG. 4. If the user name and the biometric identifier 26 do not match, the number of attempts is exhibited to the user, item 76 of FIG. 4. If the CSA counts fewer than three attempts to logon, the CSA allows the user to try again, item 78 of FIG. 4. If the number of attempts equals three, the user is ‘locked out’ and will be denied access to the CSA, item 80 of FIG. 4.

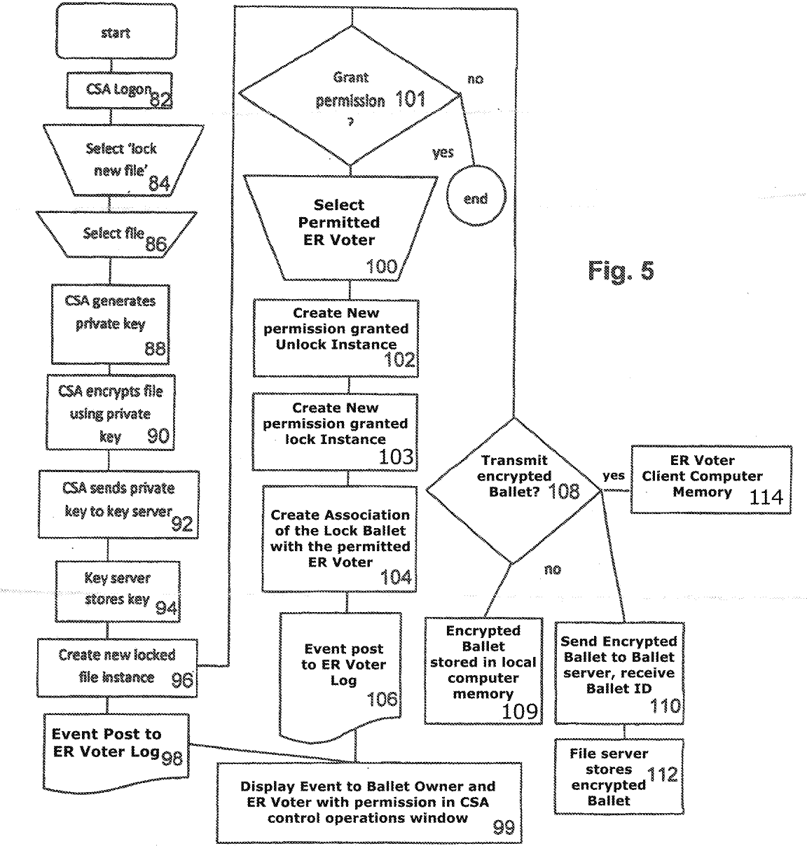

FIG. 5 illustrates the process for encrypting an electronic ballot 8 and transmitting the encrypted ballot to the client computer 5 of the ER voter. A registered user logs on to the CSA ( Client Side Application) resident on the client computer 2 of the ballot owner, as described above for FIGS. 3 and 4, item 82 of FIG. 5. The logged-in registered user is presented with the CSA control operations window which gives the user the option to select and encrypt the electronic ballot 8. The user selects ‘lock a file’, item 84 of FIG. 5. The user locates the electronic ballot 8 that is stored in the client computer memory 6 that the user wishes to encrypt and ‘lock’. The user selects the file, item 86 of FIG. 5, and commands the CSA to lock the electronic ballot 8. The user that commands the CSA to encrypt and lock the electronic ballot is known as and herein referred to as the ‘ballot owner’ 1.

Upon recieving the ‘lock’ command for the electronic ballot 8, the CSA generates a private key 18 in the temporary memory of the client computer 2 of the ballot owner, item 88 of FIG. 5. The private key 18 is generated by conventional private key encryption software that is part of the CSA. The CSA proceeds to encrypt the electronic ballot 8 using the private key 18 and the conventional private key encryption software to create an encrypted ballot 38, from item 90 of FIG. 5. The CSA transmits the private key 18 over the computer network 12 to the key server 14 which stores the private key 18 in the private key computer memory 16 of the key server 14, from items 92 and 94 of FIG. 5. Upon transmission of the private key 18 to the key server 14 the temporary memory of the client computer 2 of the ballot owner 1 is erased and overwritten.

The CSA notifies the registration server 20 of the creation of the encrypted ballot 38, which notes a ‘new locked ballot instance’ 30, from item 96 of FIG. 5. As used in this document, an ‘instance’ is an event the occurance of which is ‘logged’ and that triggers actions by the CSA, the registration server 20 or both. The event that is logged in item 96 is the encryption of the electronic ballot 8 to create an encrypted ballot 38.

Upon creation of the new locked ballot instance, item 96 of FIG. 5, the ballot owner 1 is provided the opportunity to designate an Electronically Registered Voter (herein referred to as “ER voter” 3) to whom the ballot owner 1 will grant a ‘permission’, from items 101 and 100 of FIG. 5. As used in this document, a ‘permission’ is a grant of authority to an ER voter 3 to retrieve the private key 18 from the key server 14 to unlock the encrypted ballot 38 or lock the electronic ballot 8. As stated above, the ‘ballot owner’ 1 is the registered user that initially encrypted the electronic ballot 8 and is designated as the ballot owner 1 at the time and the instance in which the original electronic ballot 8 is ‘locked’ and the encrypted ballot 38 is initially created. The ballot owner 1 may grant the permissions to unlock the encrypted ballot 38 and lock the electronic ballot 8 to an ER voter 3 and may also define the parameters of the permission(s), such as the date and time when the permission(s) will become active or expire. The ballot owner 1 may also grant the permission(s) to a group of registered users, such as a collection of certified election officials, or to a company or government agency composed of registered users, such as an election audit overseers or Department of the Secretary of State or Federal Government officials, in order to assist in the processing, counting, verification and ‘tallying’ of the completed and submitted or ‘cast’ encrypted ballots, herein referred to as cast ballot 39. The ballot owner may issue, revoke or modify any permission at any time. The permission of the ballot owner to access the private key 18 is permanent and never expires.

When the ballot owner 1 selects an eligible ER voter 3 who will be granted ‘permission(s)’, the designation of the ER voter is an ‘instance’ as previously defined. The client computer 2 of the ballot owner 1 informs the registration server 20 of this ‘permission instance’ 28 which includes both the permission to access the private key 18 to unlock the encrypted ballot 38, as shown in item 102 of FIG. 5, as well as the ‘separate’ permission to access the private key 18 to ‘lock’ or re-encrypt the electronic ballot 8, as shown in item 103 of FIG. 5, once it has been filled out and completed by the ER voter 3 prior to it being transmitted over a computer network 12 and returned to the control of the ballot owner 1. The event recorded is the designation of the ER voter 3 to be authorized to access the private key 14 to unlock the encrypted ballot 38 and to lock and ‘re-encrypt’ the completed cast ballot 39, herein referred to in this document as ‘permission(s)’. The action taken by the registration server 20 in response to the permission instance 28 is that the registration server creates an association between the ER voter 3 with permission and the encrypted file 38, as indicated by item 104 of FIG. 5. The registration server 20 also post the event to the ER voter Log 32 which records all events, actions and activities specific to each ER voter 3 that has qualified and has been designated as an eligible and approved participant in the current electronic election process. The ER voter log 32 will record an entry that lists the date, time, ballot owner and notice that permission(s) were granted to the ER voter 3 including the date and time that the permission(s) become active and the date and time that the permission(s) expire.

Upon creation of a new locked ballot instance, item 96 of FIG. 5, the ballot owner is also provided the option to transmit the encrypted ballot 38, as indicated by item 108 of FIG. 5, over the computer network 12 to the client computer 5 of the permitted ER voter 3 for storage in the ER voter local client computer memory 9, as indicated by item 114 of FIG. 5. If the ballot owner 1 does not elect to transmit the encrypted ballot 38 at that time to the permitted ER voter 3 he is provided the opportunity to upload the encrypted ballot 38 to a separate encrypted ballot server 34 which stores the encrypted ballot 38 in encrypted ballot computer memory 36, as indicated by item 112 of FIG. 5.

If the ballot owner elects not to transmit the encrypted ballot 38 to the permitted ER voter 3 nor to upload the encrypted ballot 38 to the encrypted ballot server 34 for storage in the encrypted ballot computer memory 36 he is given the option to select another location to which he can save the encrypted ballot 38. The ballot owner saves the encrypted ballot to the selected location, as indicated by item 114 of FIG. 5. The selected location may be the client computer memory 6 of the ballot owner 1 or may be any other electronic memory or designated computer memory location selected by the ballot owner 1.

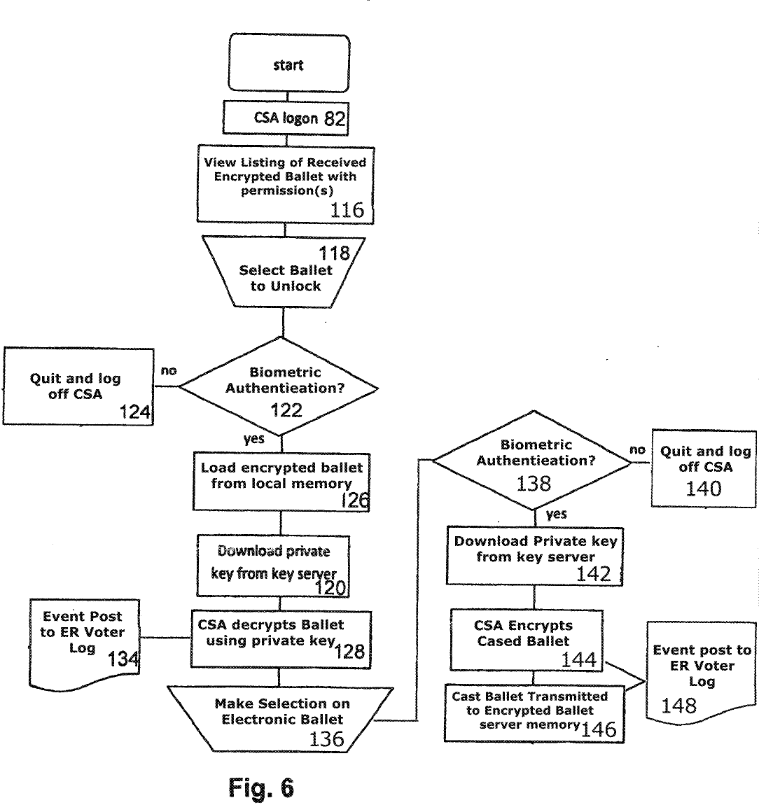

FIG. 6 illustrates the step by the ER voter 3 of accessing the information in the encrypted ballot 38 and then selecting, completing and submitting the cast ballot 39. The encrypted ballot has been received by the ER voter client computer 5 and has been stored in the local client computer memory 9 as previously indicated by item 114 of FIG. 5. The ER voter 3 first completes the CSA logon procedure of item 82 of FIG. 6. Upon logon, the CSA will display a listing of the received encrypted ballot 38 for which the ER voter 3 has been granted permission(s), as discussed above and as illustrated by item 116 of FIG. 6. The listing contains the specific information associated with the granted permission(s) such as the date and time they are active and that they expire. The encrypted ballot 38 listing and associated information is generated in real time by the registration server 20.

To unlock the encrypted ballot 38 for which the ER voter 3 has been granted permission by the ballot owner 1 to retrieve the private key 18 and decrypt and unlock the encrypted ballot, as illustrated previously in item 102 of FIG. 5, the ER voter 3 will select the listed encrypted ballot 38 from the CSA display window as indicated as item 118 on FIG. 6. The ER voter will be prompted to submit a real time biometric identifier 26 which will be matched with the biometric identifier 26 associated with the ER voter 3 that is stored in the registration server computer memory 22 in order to verify their identity, this process herein referred to as having their identity ‘biometrically authenticated’, as shown in item 122 on FIG. 6. If the ER voter 3 is unable to have their identity successfully biometrically authenticated upon the submission of a real time biometric identifier 26 then the process will end and the CSA will log off and ‘quit’, as illustrated by item 124 on FIG. 6.

If the identity of the ER voter 3 has been successfully biometrically authenticated then the CSA will load the encrypted ballot 38 that is stored in the local client computer memory 9, as shown in item 126 on FIG. 6. The CSA will send a request for the private key 18 to the Key server 14 over the computer network 12. Upon receipt of the request by the CSA the Key server 14 will obtain verification that the unlock permission 102 granted by the ballot owner 1is still current and active and if so will then transmit the private key 18 from the key server 14 to the volatile memory of the microprocessor 7 of the ER voter’s client computer 5. The client computer 5 will download the private key 18 to the RAM memory of the client computer microprocessor /, as shown in item 120 of FIG. 6.

The CSA will utilize the private key 18 to ‘unlock’ and decrypt the encrypted ballot 38 using the RAM memory of the client computer microprocessor 7, as shown in item 128 of FIG. 6 Immediately upon decryption of the encrypted ballot 38 the RAM memory of the client computer 5 will be erased and overwritten. Upon the instance of the decryption of the encrypted ballot 38 an event notification will be posted on the ER voter log 32, as shown in item 134 of FIG. 6.

The decrypted electronic ballot 8 will be displayed on the computer monitor of the client computer 5. The ER voter 3 will then make the desired choices and selections and ‘fill out’ the electronic ballot 8, as shown in item 136 of FIG. 6.

Upon the completion of the ‘voting’ and selection process the ER voter 3 will then select the ‘cast your vote’ option and will be prompted to provide a real time biometric identifier 26 in order to have their identity biometrically authenticated, as shown in item 138 of FIG. 6. If the identity of the ER voter 3 is unable to be biometrically authenticated then the CSA will log out and ‘quit’ and the selections and modifications made to the electronic ballot 8 will not be saved, as shown in item 140 of FIG. 6.

If the identity of the ER voter 3 has successfully been biometrically authenticated then the CSA will send a request for the private key 18 to the Key server 14 over the computer network 12. Upon receipt of the request by the CSA the Key server 14 will obtain verification that the lock permission 103 granted by the ballot owner 1 is still current and active and if so will then transmit the private key 18 from the key server 14 to the volatile memory of the microprocessor 7 of the ER voter’s client computer 5. The client computer 5 will download the private key 18 to the RAM memory of the client computer microprocessor 7, as shown in item 142 of FIG. 6.

The CSA will utilize the private key 18 to ‘lock’ and re-encrypt the encrypted ballot 38 using the RAM memory of the client computer microprocessor 7, as shown in item 144 of FIG. 6. Immediately upon the encryption of the completed ‘cast’ ballot 39 the RAM memory of the client computer 5 will be erased and overwritten. A ‘check sum’ or hash tag algorithm will be utilized to generate a unique value that is a specific identifier of the exact quantity of data that is contained in the completed electronic ballot at the instance it was ‘cast’. The hash tag value associated with the cast ballot 39 will be recorded and contained within all subsequent event notifications of each action and activity associated with the cast ballot 39 as an additional level of security that will ensure that no alterations or modifications have been made to data contained within.

Upon the completion of the encryption process the cast ballot 39 will be transmitted over the computer network 12 to the encrypted ballot server 34 for storage in the encrypted ballot computer memory 36, as shown in item 146 of FIG. 6. Upon the instance of the encryption of the cast ballot 39 and the transmission to the encrypted ballot server 34 an event notification will be posted on the ER voter log 32, as shown in item 148 of FIG. 6.

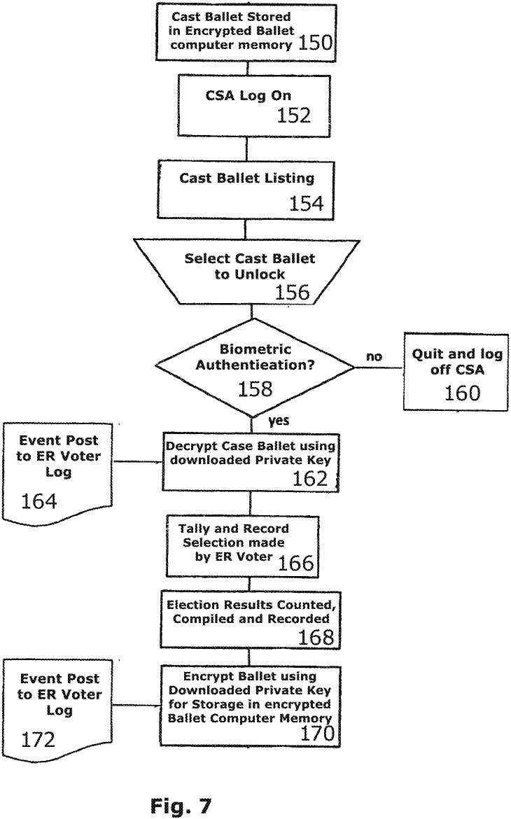

FIG. 7 details the steps taken to tally and count the cast ballot 39 after it has been transmitted to the encrypted ballot server 34 and stored in the encrypted ballot computer memory 36, as illustrated in item 150 of FIG. 7. The ballot owner 1 first completes the CSA logon procedure on the encrypted ballot server 34 as illustrated in item 152 of FIG. 7. Upon logon, the CSA will display a listing of the cast ballots 39 in which the user is identified as the ballot owner 1 that were received by the encrypted ballot server 34 and stored in the encrypted ballot computer memory 36. The listing was generated upon the instance that the cast ballot 39 was encrypted and transmitted to the encrypted ballot server 34, as shown in item 154 of FIG. 7. The listing contains the specific information associated with the ER voter 3 that has exercised the permission(s) granted by the ballot owner 1 including the time and date they were executed. The cast ballot 39 listing and associated information is generated in real time by the registration server 20 and displayed in the CSA operations window.

To unlock the cast ballot 39 for which the user is the ballot owner 1 and retrieve the private key 18 and decrypt and unlock the encrypted cast ballot 39, the ballot owner 1 will select the listed encrypted cast ballot 39 from the CSA display window as indicated as item 156 on FIG. 7. The ballot oiwner 1 will be prompted to submit a real time biometric identifier 26 which will be matched with the biometric identifier 26 associated with the ballot owner 1 that is stored in the registration server computer memory 22 in order to verify his identity, as shown in item 158 on FIG. 7 If the ballot owner 1 s unable to have their identity successfully biometrically authenticated upon the submission of a real time biometric identifier 26 then the process will end and the CSA will log off and ‘quit’, as illustrated by item 160 on FIG. 7.

If the identity of the ballot owner 1 has been successfully biometrically authenticated then the CSA will send a request for the private key 18 to the Key server 14 over the computer network 12. Upon receipt of the request by the CSA the key server 14 will transmit the private key 18 from the key server 14 to the volatile memory of the encrypted ballot server computer 34. The RAM memory of the encrypted ballot server computer 34 will utilize the private key 18 to decrypt the encrypted cast ballot 39, as shown in item 162 of FIG. 7. Upon the decryption of the cast ballot 39 the RAM memory of the encrypted ballot server computer 34 will be erased and overwritten.

The unlock instance that occurred when the cast ballot 39 was decrypted will generate an event notification that will be posted on the ER voter log 32, as illustrated by item 164 of FIG. 7.

The ballot owner 1 will then tally and record the selections made by the ER voter 3 on the casted electronic ballot 8, as illustrated by item 166 of FIG. 7. At that time the ballot owner 1 is afforded the opportunity to print and produce ‘hard copies’ of the casted electronic ballot 8 that may be ‘hand counted’ and stored as an additional level of ensuring the security and integrity of the electronic election process. The results of the election and the designated choices that were selected by the ER voter 3 will be compiled, counted and recorded, as illustrated by item 168 of FIG. 7.

The ballot owner 1 will retrieve the private key 18 from the key server 18 and encrypt the tallied electronic ballot 8 recreating the encrypted cast ballot 39 that will stored in the encrypted file computer memory 36 of the encrypted file server 34, as illustrated by item 170 of FIG. 7. An event notification of the lock file instance will be posted on the ER voter log 32, as shown by item 172 of FIG. 7.

If the cast ballot 39 is not stored in the encrypted ballot computer memory 36 the ballot owner 1 will locate the cast ballot 39 on the ballot owner client computer 2 or whatever other memory the cast ballot 39 is stored and can command the cast ballot 39 to unlock so that it can be tallied, counted and recorded.

The results of the electronic cast ballots 39 will be combined with the tallied and counted votes cast by other means, including in-person voting at designated voting centers in order to determine the outcome of the election. The ER voter log 32 will be available and referrence prior to permitting any eligible voter the opportunity to cast their vote by any alternative means in order to avoid and prevent any instances of voter fraud.

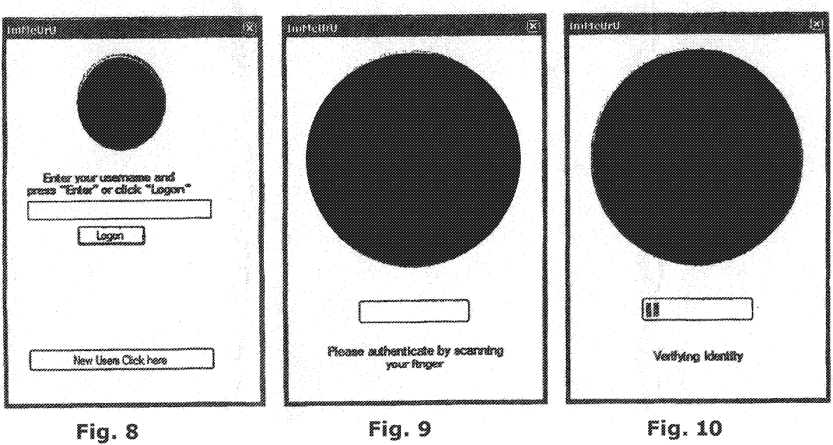

FIGS. 8 - 10 are selected screen shots of the CSA running on client computers 2, 5 presented during logon. The CSA running on client computer 2 or 5 first presents the screen of FIG. 8 to the user seeking to logon. The user is prompted for a user name and clicks logon. As shown in FIG. 9, the CSA then prompts the user to scan his or her finger using the fingerprint scanner 10 attached to client computer 2 or 5. The CSA causes the client computer 2 or 5 to transmit the user name and biometric identifier 26 generated by the fingerprint scan to the registration server computer 20 over the computer network 12, while displaying the screen of FIG. 10 to the user.

The identity of the in-person and on-site voter may be validated by means of biometric authentication in order to ensure that the voter is whom he or she claims to be. The employment of this method and means of voter identity authentication will negate the requirement that the voter be in possession of current State of Federal Identification certification in order to be eligible to participate in the electorial process.

Communication among the ballow owner client computer 2, the ER voter client computer 5, the registration server 20, the key server 14 and the encrypted ballot server 34 over the computer network 12 are secure communications using conventional https secure socket technology as currently used for Internet financial transactions. In https technology for internet communications, a public key encryption system encrypts a communication that is then transmitted over the computer network 12. The recipient of the communication decrypts the communication for use. The file is encrypted while in transit but is in decrypted form in both the transmitting and receiving computers. This https encryption of communication among client computers 2, 5 and servers 14, 20, 34 is distinct and different from the private key 18 encryption used to encrypt and decrypt the electronic ballot 38 and the cast ballot 39.

The private key encryption program ‘blowfish’ using a key size of 448 bits has proved successful in practice for private key encryption and decryption duties of the CSA. ‘Blowfish’ is an open source encryption program available at ‘Blowfish.net’. The private key 18 is created using a random number generator.

The ER voter log 32 is accessible by any internet enabled device and will require that the ER voter 3 submit the user name and a real-time biometric identifier 26 in order that their identity be biometrically authenticated in order to view the status, actions and activities associated with their electronic ballot. When the ballot owner 1 or the ER voter 3 connects to the ER voter log 32 a real time generated list of all events and actions including each lock and unlock instance activity is available to view and review.

The key server 14 will validate and authenticate the check sum and hash tag value identifier that is unique and that has been associated with each cast ballot 39 at every lock and unlock instance as a means to ensure that the integrity of the cast ballot 39 has been maintained. If the check sum and hash tag value identifier does not match the value attributed and associated to the cast ballot 39 when it was submitted a ‘red flag’ notification will be generated and the ‘instance’ operation will be suspended until an investigation is conducted that determines if the cast ballot 39 has been altered or modified.

The embodiment of the Invention is described and illustrated by reference to a specific embodiment, the electronic voting method and apparatus, however it will be apparent to those skilled in the art that various changes and modifications may be made which clearly fall within the scope of thisInvention.

A modification which should be implicit and understood by those reasonably skilled in the art is the utilization of the Invention at a conventional on-site polling location. The ballot machine and/or electronic voting kiosk would be an apparent and suitable substitute for the Electronically Registered client computer. Although the voting device would be utilized by a plurality of voters it would still function in the capacity of a unique voter’s client computer due to the biometric identity authentication component requirement that would adapt the multi-user machine into a single user ‘individualize’ device.

In similar adaptations a large scale event could employ the current Invention using a single stand alone computerized unit that would be operated at different times by different participants. This unit could facilitate the separate registration and selection functions of the present Invention by a multitude of users while eliminating fraud and maintain operational integrity and negating the conditional participation requirement of being in possession of ‘current’ State and/or Federal identification certificates.

The present Invention can be employed as a means to ensure the integrity of at home testing, board certifications and examinations, as a means to ensure the security and integrity of financial, investment, real estate and banking transactions, as a means to ensure the security and integrity of sharing and peer review of medical procedures and patient records, as a means of ensuring the security and integrity of court notices, depositions, subpoenas and legal appearances and official record and notification services.

The description as to the elements of the Invention as defined as ‘electronic ba llots’, ‘ballot owner’, and ‘ER voter’ are meant and intended as a descriptive illustration of an embodiment of the Invention and are in no way intended to limit or narrowly define the range and application of the Invention nor restrict definition of the shared and generated electronic files and the communicated recipients and participants as identified. The present Invention is intended to be protected broadly with the spirit and scope of the appended claims.

### IV. BRIEF DESCRIPTION OF THE DRAWINGS

FIG. 1 is a block diagram of the system architecture.

FIG. 2 is a flow chart of the registration process.

FIG. 3 is a flow chart of the Client Side Application logon process.

FIG. 4 is a flow chart of the IDAV process.

FIG. 5 is a flow chart of encrypting the electronic ballot.

FIG. 6 is a flow chart of decrypting and casting the electronic ballot.

FIG. 7 is a flow chart of tallying and recording the cast ballots.

FIGS. 8-10 are images of screens presented during logon of the CSA.

### V. DESCRIPTION OF AN EMBODIMENT

One aspect of the invention is an apparatus and method for a secure electronic voting system and procedure. FIG. 1 is a block diagram of the initial system architecture. A file owner 1, hereninafter defined and referred to as the ‘ballot owner’, operates a client computer 2, that includes a microprocessor 4 and a client computer memory 6. The client computer memory 6 is accessible to the microprocessor 4. The client computer memory is capable of storing an electronic file 8, (referred to in this document as the electronic ‘ballot’) The electronic ‘ballot’ 8 contains the voting information and choices that will be securely transmitted, retrieved, tallied and stored by the system. A biometric scanner 10 is connected to the microprocessor 4. The biometric scanner 10 is capable of scanning a body part of the human user to generate a biometric identifier 26. The biometric scanner 10 may be a fingerprint scanner, an iris scanner, a facial recognition scanner or any other scanning device capable of generating an electronic file that is unique to a human user and requires the ‘real-time’ presence of the human user to perform the scan. The biometric identifier 26 is an electronic file that contains the results of the biometric scan.

An electronically registered voter 3, hereninafter defined and referred to as “ER voter”, operates a client computer 5, that includes a microprocessor 7 and a client computer memory 9. The client computer memory 9 is accessible to the microprocessor 7. The client computer memory is capable of storing an electronic ballot 8. The electronic ‘ballot’ 8 will contain the voting information, selections and choices made by the ER voter 3 and will be securely recieved, stored and transmitted by the system. A biometric scanner 10 is connected to the microprocessor 7. The biometric scanner 10 is capable of scanning a body part of the human user to generate a biometric identifier 26. The biometric scanner 10 may be a fingerprint scanner, an iris scanner, a facial recognition scanner or any other scanning device capable of generating an electronic file that is unique to a human user and requires the ‘real-time’ presence of the human user to perform the scan. The biometric identifier 26 is an electronic file that contains the results of the biometric scan.

The client computer 2 in the control of the ballot owner 1 and the client computer 5 in the control of the ER voter 3 are capable of communicating with each other and with other computers over a computer network 12. The computer network 12 may be the Internet or an Intranet or may be any other network of computer capable of communicating one with another.

A key server 14 is connected to the microprocessor 4 of the client computer 2 of the ballot owner 1 and the microprocessor 7 of the client computer 5 of the ER voter 3 over the computer network 12. The key server 14 is connected to a private key computer memory 16. Private key computer memory 16 is accessible to the key server 14. Private key computer memory 16 is capable of storing a private key 18. Private key 18 is a private encryption key generated and used to encrypt the electronic ballot 8 as the term is commonly applied when the method of private key encryption is utilized.

A registration server 20 is attached to microprocessor 4 of the client computer 2 of the ballot owner 1 and the microprocessor 7 of the client computer 5 of the ER voter 3 over the computer network 12. The registration server 20 is connected to a registration server computer memory 22. The registration server computer memory 22 is capable of storing the registration status 24 of the human users, biometric identifiers 26 of registered users, permissions 28 granted by a user, and locked file instances 30 and unlock file instances 31 for each registered user, as those terms are hereinafter used and defined.

An encrypted file server 34 communicates with the client computer 2 of the ballot owner 1 and the registration server 20 over the computer network 12. An encrypted file computer memory 36 is connected to and in communication with the encrypted file server 34. The encrypted file computer memory 36 is capable of storing the encrypted ‘casted’ ballot 38, a term hereinafter used and defined, of an ER voter 3.

The encrypted file server 34 and the key server 14 are separate servers and are not the same. Encrypted file computer memory 36 is in a different physical location for the private key computer memory 16. Maintaining encrypted file computer memory 36 and private key computer memory 16 at different physical locations prevents the loss of both an encrypted ballot 38 and the private key 18 to unlock the encrypted ballot in a single action of physical theivery or a single incident of hacking.

FIG. 2 is a flow chart illustrating the registration process to transform a user into a registered user authorized as the electronic ballot owner 1 or as an E.R. voter 3 that can participate in the secure voting system and procedure appartus and method of the Invention. A human user utilizing client computer 2 or client computer 5 navigates through the computer network 12 to the registration server 20, illustrated as item 40. The registration server 20 will request, and the user will select, a user name, which the microprocessor 4 of client computer 2 or the microprocessor 7 of client computer 5 transmits to the registration server 20 over the computer network 12, shown by item 42 of FIG. 2.

During the registration process, the registration server 20 will transmit a Client Side Application (“CSA”) to the client computer over the computer network 12, as shown by item 50.

The client computer will install the CSA as shown by item 52. The CSA is a computer program resident in client computer memory 6 or client computer memory 9 that automates many of the encryption, decryption and communication functions of the apparatus and method of the Invention. The CSA also provides gatekeeper functions in allowing or refusing access by the user to the registration server 20, key server 14 and encryption file server 34.

The registration server 20 will request a biometric identifier 26. The user uses biometric scanner 10 to scan a body part of the user, for example the user’s fingerprint, as illustrated by item 44. The microprocessor will tranmit the biometric identifier 26 to the registration server 20, as shown by item 46. The registration server 20 will create a registration account for user, transforming the user into a registered user as shown by item 48. The registration server 20 will associate the user name and the submitted biometric identifiers 26.

The registered user may be an individual. Alternatively, a group or company may be registered comprising more than one individual under the control of a chairman. Where a group or company comprises more than one individual, each individual nonetheless will provide biometric identifiers 26, which may be one or more scans of a body part of the individual by biometric scanner 10. The biometric identifier 26 and username of each person in the group or company will serve to allow each group member or company employee (i.e. such as a certified election official) to identify him or herself to the registration server 20 to allow access to the encrypted ballots 38 and associated private keys 18. The chairman of the group or company can determine access limitations of individual members of the group or employees of the company.

The process of encrypting and decrypting a file using a private key 18 are also referred to in this document as ‘locking’ and ‘unlocking’ the ballot. ‘Locking’ means ‘encrypting’. ‘Unlocking’ means ‘decrypting’. An encrypted ballot 38 is also referred to as a ‘locked ballot’ 38 while an unencrypted electronic ballot 8 is referred to as an ‘unlocked ballot’ 8.

To access the encryption and decryption functions of the apparatus and method, the user logs on to the CSA resident client computer 2 or client computer 5. FIG. 3 is a flow chart illustrating the CSA logon process. To log on to the CSA, the registered user will open the CSA (Client Side Application) on client computer 2 or client computer 5. The registered user will input the user’s member ID, also referred to herein as the ‘user name’, indicated as item 54 on FIG. 3. The CSA will consult with the registration server 20 over computer network 12 to determine whether the user is ‘locked out’, item 56 of FIG. 3. If the CSA recieves notice from the registration server 20 that the registered user is ‘locked out’ and prohibited from ‘logging on’, the CSA will require the user to go through the identification process shown by FIG. 4. The registration server might lock out a registered user for electronic voter disqualification or ineligibility, for activity on the user’s account that may indicate a security breach, or for any other reason.

If the user is not ‘locked out’, the CSA will request that the registered user provide a biometric identifier 26, which may be a fingerprint as illustrated by item 58 of FIG. 3. The registered user will place his or her finger on the biometric scanner 10, which will scan a body part of the user. Client computer 2 or client computer 5 will generate a ‘real-time’ biometric identifier 26, which client computer 2 or client computer 5 will transmit to the registration server 20 over the computer network 12. The registration server will verify the identity of the user, item 60 of FIG. 3, by comparing the biometric identifier 26 received from client computer 2 or client computer 5 to the biometric identifier 26 associated with the user’s user name in registration computer memory 22. If the registration server 20 concludes that the biometric identifier 26 recieved from client computer 2 or client computer 5 is from the same person as the biometric identifier 26 stored in the registration computer memory 22 and associated with the user’s user name, the registration server will conclude that the registered user is who he or she claims to be and their identity will have been ‘blometrically authenticated’.

The registration server 20 will also check the current status and ‘voter eligibility’ of the electronically registered voter (ER voter). If the user is the ER voter who he or she claims to be and if their current status and voter eligibility is active and approved then the CSA will display the CSA Control Operations Window and information field screen to the ER voter, item 64 of FIG. 3 to allow the ER voter to decrypt and encrypt the electronic ballot. If the ER voter status is not active and they are not currently eligible to vote electronically the CSA will so indicate to the ER voter, shown by item 66 of FIG. 3, and not allow access to the CSA Control Operations Window and information field screen to the unapproved ER voter.

If the initial logon to the CSA is not successful in matching the user name to the biometric identifier 26 stored in the registration computer memory 22, or if an inaccurate member name was entered on a third failed attempt, the application will ‘auto-quit’ and close. In the process illustrated by FIG. 4, the user for whom the biometric identifier 26 and user name did not match is given two more attempts to logon. The user will re-input the user’s user name, indicated by item 68 of FIG. 4. The user submits another biometric identifier 26, such as a fingerprint scan, from item 70 of FIG. 4. If the user name and the biometric identifier 26 match those stored in the registration computer memory 22, from item 72 on FIG. 4, then the user is allowed to logon to the CSA, item 74 of FIG. 4. If the user name and the biometric identifier 26 do not match, the number of attempts is exhibited to the user, item 76 of FIG. 4. If the CSA counts fewer than three attempts to logon, the CSA allows the user to try again, item 78 of FIG. 4. If the number of attempts equals three, the user is ‘locked out’ and will be denied access to the CSA, item 80 of FIG. 4.

FIG. 5 illustrates the process for encrypting an electronic ballot 8 and transmitting the encrypted ballot to the client computer 5 of the ER voter. A registered user logs on to the CSA ( Client Side Application) resident on the client computer 2 of the ballot owner, as described above for FIGS. 3 and 4, item 82 of FIG. 5. The logged-in registered user is presented with the CSA control operations window which gives the user the option to select and encrypt the electronic ballot 8. The user selects ‘lock a file’, item 84 of FIG. 5. The user locates the electronic ballot 8 that is stored in the client computer memory 6 that the user wishes to encrypt and ‘lock’. The user selects the file, item 86 of FIG. 5, and commands the CSA to lock the electronic ballot 8. The user that commands the CSA to encrypt and lock the electronic ballot is known as and herein referred to as the ‘ballot owner’ 1.

Upon recieving the ‘lock’ command for the electronic ballot 8, the CSA generates a private key 18 in the temporary memory of the client computer 2 of the ballot owner, item 88 of FIG. 5. The private key 18 is generated by conventional private key encryption software that is part of the CSA. The CSA proceeds to encrypt the electronic ballot 8 using the private key 18 and the conventional private key encryption software to create an encrypted ballot 38, from item 90 of FIG. 5. The CSA transmits the private key 18 over the computer network 12 to the key server 14 which stores the private key 18 in the private key computer memory 16 of the key server 14, from items 92 and 94 of FIG. 5. Upon transmission of the private key 18 to the key server 14 the temporary memory of the client computer 2 of the ballot owner 1 is erased and overwritten.

The CSA notifies the registration server 20 of the creation of the encrypted ballot 38, which notes a ‘new locked ballot instance’ 30, from item 96 of FIG. 5. As used in this document, an ‘instance’ is an event the occurance of which is ‘logged’ and that triggers actions by the CSA, the registration server 20 or both. The event that is logged in item 96 is the encryption of the electronic ballot 8 to create an encrypted ballot 38.

Upon creation of the new locked ballot instance, item 96 of FIG. 5, the ballot owner 1 is provided the opportunity to designate an Electronically Registered Voter (herein referred to as “ER voter” 3) to whom the ballot owner 1 will grant a ‘permission’, from items 101 and 100 of FIG. 5. As used in this document, a ‘permission’ is a grant of authority to an ER voter 3 to retrieve the private key 18 from the key server 14 to unlock the encrypted ballot 38 or lock the electronic ballot 8. As stated above, the ‘ballot owner’ 1 is the registered user that initially encrypted the electronic ballot 8 and is designated as the ballot owner 1 at the time and the instance in which the original electronic ballot 8 is ‘locked’ and the encrypted ballot 38 is initially created. The ballot owner 1 may grant the permissions to unlock the encrypted ballot 38 and lock the electronic ballot 8 to an ER voter 3 and may also define the parameters of the permission(s), such as the date and time when the permission(s) will become active or expire. The ballot owner 1 may also grant the permission(s) to a group of registered users, such as a collection of certified election officials, or to a company or government agency composed of registered users, such as an election audit overseers or Department of the Secretary of State or Federal Government officials, in order to assist in the processing, counting, verification and ‘tallying’ of the completed and submitted or ‘cast’ encrypted ballots, herein referred to as cast ballot 39. The ballot owner may issue, revoke or modify any permission at any time. The permission of the ballot owner to access the private key 18 is permanent and never expires.

When the ballot owner 1 selects an eligible ER voter 3 who will be granted ‘permission(s)’, the designation of the ER voter is an ‘instance’ as previously defined. The client computer 2 of the ballot owner 1 informs the registration server 20 of this ‘permission instance’ 28 which includes both the permission to access the private key 18 to unlock the encrypted ballot 38, as shown in item 102 of FIG. 5, as well as the ‘separate’ permission to access the private key 18 to ‘lock’ or re-encrypt the electronic ballot 8, as shown in item 103 of FIG. 5, once it has been filled out and completed by the ER voter 3 prior to it being transmitted over a computer network 12 and returned to the control of the ballot owner 1. The event recorded is the designation of the ER voter 3 to be authorized to access the private key 14 to unlock the encrypted ballot 38 and to lock and ‘re-encrypt’ the completed cast ballot 39, herein referred to in this document as ‘permission(s)’. The action taken by the registration server 20 in response to the permission instance 28 is that the registration server creates an association between the ER voter 3 with permission and the encrypted file 38, as indicated by item 104 of FIG. 5. The registration server 20 also post the event to the ER voter Log 32 which records all events, actions and activities specific to each ER voter 3 that has qualified and has been designated as an eligible and approved participant in the current electronic election process. The ER voter log 32 will record an entry that lists the date, time, ballot owner and notice that permission(s) were granted to the ER voter 3 including the date and time that the permission(s) become active and the date and time that the permission(s) expire.

Upon creation of a new locked ballot instance, item 96 of FIG. 5, the ballot owner is also provided the option to transmit the encrypted ballot 38, as indicated by item 108 of FIG. 5, over the computer network 12 to the client computer 5 of the permitted ER voter 3 for storage in the ER voter local client computer memory 9, as indicated by item 114 of FIG. 5. If the ballot owner 1 does not elect to transmit the encrypted ballot 38 at that time to the permitted ER voter 3 he is provided the opportunity to upload the encrypted ballot 38 to a separate encrypted ballot server 34 which stores the encrypted ballot 38 in encrypted ballot computer memory 36, as indicated by item 112 of FIG. 5.

If the ballot owner elects not to transmit the encrypted ballot 38 to the permitted ER voter 3 nor to upload the encrypted ballot 38 to the encrypted ballot server 34 for storage in the encrypted ballot computer memory 36 he is given the option to select another location to which he can save the encrypted ballot 38. The ballot owner saves the encrypted ballot to the selected location, as indicated by item 114 of FIG. 5. The selected location may be the client computer memory 6 of the ballot owner 1 or may be any other electronic memory or designated computer memory location selected by the ballot owner 1.

FIG. 6 illustrates the step by the ER voter 3 of accessing the information in the encrypted ballot 38 and then selecting, completing and submitting the cast ballot 39. The encrypted ballot has been received by the ER voter client computer 5 and has been stored in the local client computer memory 9 as previously indicated by item 114 of FIG. 5. The ER voter 3 first completes the CSA logon procedure of item 82 of FIG. 6. Upon logon, the CSA will display a listing of the received encrypted ballot 38 for which the ER voter 3 has been granted permission(s), as discussed above and as illustrated by item 116 of FIG. 6. The listing contains the specific information associated with the granted permission(s) such as the date and time they are active and that they expire. The encrypted ballot 38 listing and associated information is generated in real time by the registration server 20.

To unlock the encrypted ballot 38 for which the ER voter 3 has been granted permission by the ballot owner 1 to retrieve the private key 18 and decrypt and unlock the encrypted ballot, as illustrated previously in item 102 of FIG. 5, the ER voter 3 will select the listed encrypted ballot 38 from the CSA display window as indicated as item 118 on FIG. 6. The ER voter will be prompted to submit a real time biometric identifier 26 which will be matched with the biometric identifier 26 associated with the ER voter 3 that is stored in the registration server computer memory 22 in order to verify their identity, this process herein referred to as having their identity ‘biometrically authenticated’, as shown in item 122 on FIG. 6. If the ER voter 3 is unable to have their identity successfully biometrically authenticated upon the submission of a real time biometric identifier 26 then the process will end and the CSA will log off and ‘quit’, as illustrated by item 124 on FIG. 6.

If the identity of the ER voter 3 has been successfully biometrically authenticated then the CSA will load the encrypted ballot 38 that is stored in the local client computer memory 9, as shown in item 126 on FIG. 6. The CSA will send a request for the private key 18 to the Key server 14 over the computer network 12. Upon receipt of the request by the CSA the Key server 14 will obtain verification that the unlock permission 102 granted by the ballot owner 1 is still current and active and if so will then transmit the private key 18 from the key server 14 to the volatile memory of the microprocessor 7 of the ER voter’s client computer 5. The client computer 5 will download the private key 18 to the RAM memory of the client computer microprocessor 7, as shown in item 120 of FIG. 6.

The CSA will utilize the private key 18 to ‘unlock’ and decrypt the encrypted ballot 38 using the RAM memory of the client computer microprocessor 7, as shown in item 128 of FIG. 6. Immediately upon decryption of the encrypted ballot 38 the RAM memory of the client computer 5 will be erased and overwritten. Upon the instance of the decryption of the encrypted ballot 38 an event notification will be posted on the ER voter log 32, as shown in item 134 of FIG. 6.

The decrypted electronic ballot 8 will be displayed on the computer monitor of the client computer 5. The ER voter 3 will then make the desired choices and selections and ‘fill out’ the electronic ballot 8, as shown in item 136 of FIG. 6.

Upon the completion of the ‘voting’ and selection process the ER voter 3 will then select the ‘cast your vote ’ option and will be prompted to provide a real time biometric identifier 26 in order to have their identity biometrically authenticated, as shown in item 138 of FIG. 6. If the identity of the ER voter 3 is unable to be biometrically authenticated then the CSA will log out and ‘quit’ and the selections and modifications made to the electronic ballot 8 will not be saved, as shown in item 140 of FIG. 6.

If the identity of the ER voter 3 has successfully been biometrically authenticated then the CSA will send a request for the private key 18 to the Key server 14 over the computer network 12. Upon receipt of the request by the CSA the Key server 14 will obtain verification that the lock permission 103 granted by the ballot owner 1 is still current and active and if so will then transmit the private key 18 from the key server 14 to the volatile memory of the microprocessor 7 of the ER voter’s client computer 5. The client computer 5 will download the private key 18 to the RAM memory of the client computer microprocessor 7, as shown in item 142 of FIG. 6.

The CSA will utilize the private key 18 to ‘lock’ and re-encrypt the encrypted ballot 38 using the RAM memory of the client computer microprocessor 7, as shown in item 144 of FIG. 6. Immediately upon the encryption of the completed ‘cast’ ballot 39 the RAM memory of the client computer 5 will be erased and overwritten. A ‘check sum’ or hash tag algorithm will be utilized to generate a unique value that is a specific identifier of the exact quantity of data that is contained in the completed electronic ballot at the instance it was ‘cast’. The hash tag value associated with the cast ballot 39 will be recorded and contained within all subsequent event notifications of each action and activity associated with the cast ballot 39 as an additional level of security that will ensure that no alterations or modifications have been made to data contained within.

Upon the completion of the encryption process the cast ballot 39 will be transmitted over the computer network 12 to the encrypted ballot server 34 for storage in the encrypted ballot computer memory 36, as shown in item 146 of FIG. 6. Upon the instance of the encryption of the cast ballot 39 and the transmission to the encrypted ballot server 34 an event notification will be posted on the ER voter log 32, as shown in item 148 of FIG. 6.

FIG. 7 details the steps taken to tally and count the cast ballot 39 after it has been transmitted to the encrypted ballot server 34 and stored in the encrypted ballot computer memory 36, as illustrated in item 150 of FIG. 7. The ballot owner 1 first completes the CSA logon procedure on the encrypted ballot server 34 as illustrated in item 152 of FIG. 7. Upon logon, the CSA will display a listing of the cast ballots 39 in which the user is identified as the ballot owner 1 that were received by the encrypted ballot server 34 and stored in the encrypted ballot computer memory 36. The listing was generated upon the instance that the cast ballot 39 was encrypted and transmitted to the encrypted ballot server 34, as shown in item 154 of FIG. 7. The listing contains the specific information associated with the ER voter 3 that has exercised the permission(s) granted by the ballot owner 1 including the time and date they were executed. The cast ballot 39 listing and associated information is generated in real time by the registration server 20 and displayed in the CSA operations window.

To unlock the cast ballot 39 for which the user is the ballot owner 1 and retrieve the private key 18 and decrypt and unlock the encrypted cast ballot 39, the ballot owner 1 will select the listed encrypted cast ballot 39 from the CSA display window as indicated as item 156 on FIG. 7. The ballot oiwner 1 will be prompted to submit a real time biometric identifier 26 which will be matched with the biometric identifier 26 associated with the ballot owner 1 that is stored in the registration server computer memory 22 in order to verify his identity, as shown in item 158 on FIG. 7 If the ballot owner 1 s unable to have their identity successfully biometrically authenticated upon the submission of a real time biometric identifier 26 then the process will end and the CSA will log off and ‘quit’, as illustrated by item 160 on FIG. 7.

If the identity of the ballot owner 1 has been successfully biometrically authenticated then the CSA will send a request for the private key 18 to the Key server 14 over the computer network 12. Upon receipt of the request by the CSA the key server 14 will transmit the private key 18 from the key server 14 to the volatile memory of the encrypted ballot server computer 34. The RAM memory of the encrypted ballot server computer 34 will utilize the private key 18 to decrypt the encrypted cast ballot 39, as shown in item 162 of FIG. 7. Upon the decryption of the cast ballot 39 the RAM memory of the encrypted ballot server computer 34 will be erased and overwritten.

The unlock instance that occurred when the cast ballot 39 was decrypted will generate an event notification that will be posted on the ER voter log 32, as illustrated by item 164 of FIG. 7.

The ballot owner 1 will then tally and record the selections made by the ER voter 3 on the casted electronic ballot 8, as illustrated by item 166 of FIG. 7. At that time the ballot owner 1 is afforded the opportunity to print and produce ‘hard copies’ of the casted electronic ballot 8 that may be ‘hand counted’ and stored as an additional level of ensuring the security and integrity of the electronic election process. The results of the election and the designated choices that were selected by the ER voter 3 will be compiled, counted and recorded, as illustrated by item 168 of FIG. 7.

The ballot owner 1 will retrieve the private key 18 from the key server 18 and encrypt the tallied electronic ballot 8 recreating the encrypted cast ballot 39 that will stored in the encrypted file computer memory 36 of the encrypted file server 34, as illustrated by item 170 of FIG. 7. An event notification of the lock file instance will be posted on the ER voter log 32, as shown by item 172 of FIG. 7.

If the cast ballot 39 is not stored in the encrypted ballot computer memory 36 the ballot owner 1 will locate the cast ballot 39 on the ballot owner client computer 2 or whatever other memory the cast ballot 39 is stored and can command the cast ballot 39 to unlock so that it can be tallied, counted and recorded.

The results of the electronic cast ballots 39 will be combined with the tallied and counted votes cast by other means, including in-person voting at designated voting centers in order to determine the outcome of the election. The ER voter log 32 will be available and referrence prior to permitting any eligible voter the opportunity to cast their vote by any alternative means in order to avoid and prevent any instances of voter fraud.

FIGS. 8 - 10 are selected screen shots of the CSA running on client computers 2, 5 presented during logon. The CSA running on client computer 2 or 5 first presents the screen of FIG. 8 to the user seeking to logon. The user is prompted for a user name and clicks logon. As shown in FIG. 9, the CSA then prompts the user to scan his or her finger using the fingerprint scanner 10 attached to client computer 2 or 5. The CSA causes the client computer 2 or 5 to transmit the user name and biometric identifier 26 generated by the fingerprint scan to the registration server computer 20 over the computer network 12, while displaying the screen of FIG. 10 to the user.

The identity of the in-person and on-site voter may be validated by means of biometric authentication in order to ensure that the voter is whom he or she claims to be. The employment of this method and means of voter identity authentication will negate the requirement that the voter be in possession of current State of Federal Identification certification in order to be eligible to participate in the electorial process.

Communication among the ballow owner client computer 2, the ER voter client computer 5, the registration server 20, the key server 14 and the encrypted ballot server 34 over the computer network 12 are secure communications using conventional https secure socket technology as currently used for Internet financial transactions. In https technology for internet communications, a public key encryption system encrypts a communication that is then transmitted over the computer network 12. The recipient of the communication decrypts the communication for use. The file is encrypted while in transit but is in decrypted form in both the transmitting and receiving computers. This https encryption of communication among client computers 2, 5 and servers 14, 20, 34 is distinct and different from the private key 18 encryption used to encrypt and decrypt the electronic ballot 38 and the cast ballot 39.

The private key encryption program ‘blowfish’ using a key size of 448 bits has proved successful in practice for private key encryption and decryption duties of the CSA. ‘Blowfish’ is an open source encryption program available at ‘Blowfish.net’. The private key 18 is created using a random number generator.

The ER voter log 32 is accessible by any internet enabled device and will require that the ER voter 3 submit the user name and a real-time biometric identifier 26 in order that their identity be biometrically authenticated in order to view the status, actions and activities associated with their electronic ballot. When the ballot owner 1 or the ER voter 3 connects to the ER voter log 32 a real time generated list of all events and actions including each lock and unlock instance activity is available to view and review.

The key server 14 will validate and authenticate the check sum and hash tag value identifier that is unique and that has been associated with each cast ballot 39 at every lock and unlock instance as a means to ensure that the integrity of the cast ballot 39 has been maintained. If the check sum and hash tag value identifier does not match the value attributed and associated to the cast ballot 39 when it was submitted a ‘red flag’ notification will be generated and the ‘instance’ operation will be suspended until an investigation is conducted that determines if the cast ballot 39 has been altered or modified.

The embodiment of the Invention is described and illustrated by reference to a specific embodiment, the electronic voting method and apparatus, however it will be apparent to those skilled in the art that various changes and modifications may be made which clearly fall within the scope of thisInvention.

A modification which should be implicit and understood by those reasonably skilled in the art is the utilization of the Invention at a conventional on-site polling location. The ballot machine and/or electronic voting kiosk would be an apparent and suitable substitute for the Electronically Registered client computer. Although the voting device would be utilized by a plurality of voters it would still function in the capacity of a unique voter’s client computer due to the biometric identity authentication component requirement that would adapt the multi-user machine into a single user ‘individualize’ device.

In similar adaptations a large scale event could employ the current Invention using a single stand alone computerized unit that would be operated at different times by different participants. This unit could facilitate the separate registration and selection functions of the present Invention by a multitude of users while eliminating fraud and maintain operational integrity and negating the conditional participation requirement of being in possession of ‘current’ State and/or Federal identification certificates.

The present Invention can be employed as a means to ensure examinations, as a means to ensure the security and integrity of financial, investment, real estate and banking transactions, as a means to ensure the security and integrity of sharing and peer review of medical procedures and patient records, as a means of ensuring the security and integrity of court notices, depositions, subpoenas and legal appearances and official record and notification services.

The description as to the elements of the Invention as defined as ‘electronic ba llots’, ‘ballot owner’, and ‘ER voter’ are meant and intended as a descriptive illustration of an embodiment of the Invention and are in no way intended to limit or narrowly define the range and application of the Invention nor restrict definition of the shared and generated electronic files and the communicated recipients and participants as identified. The present Invention is intended to be protected broadly with the spirit and scope of the appended claims.

I claim:

1-38. (canceled)

39. A method for secure electronic voting, the method comprising:
enrolling a user as a registered user by transmitting a registration biometric identifier over a computer network to a registration server and storing the registration biometric identifier in a computer memory of the registration server;
transmitting a first biometric identifier to the registration server and matching the first biometric identifier with a stored biometric identifier of the registered user to verify an identity of the registered user.

40. The method of claim 39, further comprising:
generating a private encryption key in a temporary memory of a client computer and using the private encryption key to encrypt an electronic ballot to create an encrypted ballot;
transmitting, by the client computer, the private encryption key to a private key server and storing the private encryption key in a computer memory of the private key server upon encrypting the electronic ballot, wherein the private key server is located at a different and separate physical location from the encrypted ballot;
erasing and overwriting the temporary memory of the client computer upon transmission of the private encryption key to the private key server.

41. The method of claim 40, further comprising:
wherein the ballot owner is the registered user that initially commanded the client computer to encrypt the electronic ballot to create the encrypted ballot;
wherein said ballot owner always has a permission to request the private encryption key and decrypt said encrypted ballot and said permission does not expire and continues indefinitely.

42. The method of claim 41, further comprising :
upon enrolling the user as the registered user, creating a registered user log that is accessible from any internet enabled device capable of generating a biometric identifier of the registered user;
posting a notification of all actions and activities associated with said registered user and said registered user’s electronic ballot on said registered user log.

43. The method of claim 42, further comprising :
granting, by the ballot owner of the encrypted ballot, a permission to a registered user authorizing the permitted registered user;
to access the private encryption key and decrypt the encrypted ballot creating a decrypted electronic ballot; and
to access the private encryption key and encrypt the decrypted electronic ballot.

44. The method of claim 43, further comprising :
granting, by the ballot owner, a permission to individuals, groups or companies of registered users authorizing them as permitted registered users;
granting, by the ballot owner, a permission for a specific duration that will expire and become inactive on a specified date and time;
granting, limiting or restricting, by the ballot owner, a permission at the time of the encryption of the electronic ballot; or
granting, limiting, modifying or revoking, by the ballot owner, a permission any time after the encryption of the electronic ballot.

45. The method of claim 44, further comprising:
transmitting, by the client computer, a third biometric identifier to the registration server and matching it with a stored biometric identifer of the permitted user to verify an identity of the permitted registered user;
transmitting, by the client computer, a request to the private key server to retrieve the private encryption key for the encrypted ballot;
receiving, by the permitted registered user, the private encryption key in the temporary memory of the client computer and decrypting the encrypted ballot; and
erasing and overwriting the temporary memory of the client computer upon decryption of the encrypted ballot.

46. The method of claim 45, further comprising:
transmitting, by the client computer, a fourth biometric identifier to the registration server and matching it with a stored biometric identifier of the permitted user to verify an identity of the permitted registered user;
transmitting, by the client computer, a request to the private key server to retrieve the private encryption key for the decrypted electronic ballot;
receiving, by the permitted registered user, the private encryption key in the temporary memory of the client computer and encrypting the electronic ballot; and
erasing and overwriting the temporary memory of the client computer upon encryption of the electronic ballot.

47. The method of claim 46, further comprising:
transmitting, by the client computer, a fifth biometric identifier to the registration server and matching it with a stored biometric identifier of the ballot owner to verify an identity of the ballot owner;
transmitting, by the client computer, a request to the private key server to retrieve the private encryption key for the encrypted ballot;
receiving, by the ballot owner, the private encryption key in the temporary memory of the client computer and decrypting the encrypted ballot; and
erasing and overwriting the temporary memory of the client computer upon decryption of the encrypted ballot.

48. The method of claim 47, further comprising :
transmitting, by the client computer, a sixth biometric identifier to the registration server and matching it with a stored biometric identifier of the ballot owner to verify an identity of the ballot owner;
transmitting, by the client computer, a request to the private key server to retrieve the private encryption key for the decrypted electronic ballot;
receiving, by the ballot owner, the private encryption key in the temporary memory of the client computer and encrypting the decrypted electronic ballot; and
erasing and overwriting the temporary memory of the client computer upon encryption of the decrypted electronic ballot.

49. The method of claim 48, further comprising :
uploading, by the ballot owner, the encrypted ballot to a selected encrypted ballot server located at a different and separate physical location from the private key server.

50. A system for secure electronic voting, the system comprising:
a client computer configured to transmit a registration biometric identifier of a user over a computer network;
a registration server configured to enroll the user as a registered user upon receiving the registration biometric identifier from the client computer over the computer network and storing the biometric identifier in a computer memory of the registration server;
wherein the client computer is further configured to transmit a first biometric identifier to the registration server, and the registration server is further configured to match the first biometric identifier with a stored biometric identifier of the registered user to verify an identity of the user as the registered user.

51. The system of claim 50, further comprising:
a private key encryption software configured to generate a private encryption key in a temporary memory of the client computer, and use the private key to encrypt an electronic ballot to create an encrypted ballot;
a private key server configured to receive, from the client computer, the private encryption key upon the encryption of the electronic ballot, and store the private encryption key in a computer memory of the private key server, wherein the private key server is located at a different and separate physical location from the encrypted ballot;
wherein the client computer is further configured to erase and overwrite the temporary memory of the client computer upon the transmission of the private encryption key to the private key server.

52. The system of claim 51, further comprising :
wherein the registered user who initially commands the client computer to create the encrypted ballot is the ballot owner of the encrypted ballot;
wherein the registered server is further configured to ensure that said ballot owner always has a permission to request the private encryption key and decrypt the encrypted ballot and that said permission does not expire and continues indefinitely.

53. The system of claim 52, further comprising :
wherein the registration server is further configured to, upon enrolling the user as the registered user, create a registered user log that is accessible from any internet enabled device capable of generating a biometric identifier of the registered user;
where in the registration server is further configured to post a notification of all actions and activities associated with said registered user and said registered user’s electronic ballot on said registered user log.

54. The system of claim 53, further comprising :
wherein the ballot owner of the encrypted ballot grants a permission to a registered user authorizing the permitted registered user;
permission to access the private encryption key to decrypt the encrypted ballot creating a decrypted electronic ballot; and
permission to access the private encryption key to encrypt the decrypted electronic ballot.

55. The system of claim 54, further comprising:
wherein the registration server is further configured to permit granting, by the ballot owner, a permission to individuals, groups or companies of registered users authorizing them as permitted registered users;
the registration server is further configured to permit granting, by the ballot owner, a permission for a specific duration that will expire and become inactive on a specified date and time;
the registration server is further configured to permit granting, limiting or restricting, by the ballot owner, a permission at the time of the encryption of the electronic ballot; or
the registration server is further configured to permit granting, limiting, modifying or revoking, by the ballot owner, a permission any time after the encryption of the electronic ballot.

56. The system of claim 55, further comprising :
where the client computer is further configured to transmit a third biometric identifier to the registration server, and the registration server is further configured to match the third biometric identifier with a stored biometric identifier to verify the identity of the registered user as a permitted registered user;
wherein the private key server is further configured to receive, from the permitted registered user, a request to retrieve the private encryption key for the encrypted ballot;
wherein the client computer Is further configured to receive the private encryption key and store the private encryption key in the temporary memory of the client computer and decrypt the encrypted ballot; and
wherein the client computer is further configured to erase and overwrite the temporary memory of the client computer upon decryption of the encrypted ballot.

57. The system of claim 56, further comprising:
where the client computer is further configured to transmit a fourth biometric identifier to verify the identity of the registered user as a permitted registered user;
wherein the private key server is further configured to receive, from the permitted registered user, a request to retrieve the private encryption key for the decrypted electronic ballot;
wherein the client computer is further configured to receive the private encryption key and store the private encryption key in the temporary memory of the client computer and encrypt the decrypted electronic ballot; and
wherein the client computer is further configured to erase and overwrite the temporary memory of the client computer upon encryption of the decrypted electronic ballot.

58. The system of claim 57, further comprising :
where the client computer is further configured to transmit a fifth biometric identifier to verify the identity of the registered user as the ballot owner;
wherein the private key server is further configured to receive, from the ballot owner, a request to retrieve the private encryption key for the encrypted ballot;
wherein the client computer is further configured to receive the private encryption key and store the private encryption key in the temporary memory of the client computer and decrypt the encrypted ballot; and
wherein the client computer is further configured to erase and overwrite the temporary memory of the client computer upon decryption of the encrypted ballot.

59. The system of claim 58, further comprising:
where the client computer is further configured to transmit a sixth biometric identifier to the registration server, and the registration server is further configured to match the sixth biometric identifier with a stored owner;
wherein the private key server is further configured to receive, from the ballot owner, a request to retrieve the private encryption key for the decrypted electronic ballot;
wherein the client computer is further configured to receive the private encryption key and store the private encryption key in the temporary memory of the client computer and encrypt the decrypted electronic ballot; and
wherein the client computer is further configured to erase and overwrite the temporary memory of the client computer upon encryption of the decrypted electronic ballot.

60. The system of claim 59, further comprising :
wherein the client computer of the ballot owner is further configured to upload the encrypted ballot to an encrypted ballot server for storage in a different and separate physical location from the private key server.
